(19) United States
(12) Patent Application Publication
(10) Pub. No.: US 2018/0235395 A1
(43) Pub. Date: Aug. 23, 2018

(54) Food Steaming Assembly

(71) Applicant: Emma Gomez, Anchorage, AK (US)

(72) Inventor: Emma Gomez, Anchorage, AK (US)

(21) Appl. No.: 15/437,987

(22) Filed: Feb. 21, 2017

(51) Int. Cl. A47J 27/04

(52) U.S. Cl. CPC A47J 27/04; A47J 2027/043

(57) ABSTRACT

A food steaming assembly for steaming food includes a pot that is configured to position water. An extrusion is coupled to and extends from an inner surface of the pot. A tray, which has a circumference that is substantially complementary to a perimeter of the pot, is positionable within the pot on the extrusion and above the water. An aperture is centrally positioned through the tray. A tube, which has opposing ends that are complementary to the aperture, is reversibly couplable to the tray such that the tube is alignably positioned with the aperture. The tube is configured to allow a user to observe a level of the water in the pot and to add water, as required, through the tube into the pot.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to steaming assemblies and more particularly pertains to a new steaming assembly for steaming food.

### BRIEF SUMMARY OF THE INVENTION

An embodiment of the disclosure meets the needs presented above by generally comprising a pot that is configured to position water. An extrusion is coupled to and extends from an inner surface of the pot. A tray, which has a circumference that is substantially complementary to a perimeter of the pot, is positionable within the pot on the extrusion and above the water. An aperture is centrally positioned through the tray. A tube, which has opposing ends that are complementary to the aperture, is reversibly couplable to the tray such that the tube is alignably positioned with the aperture. The tube is configured to allow a user to observe a level of the water in the pot and to add water, as required, through the tube into the pot.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric perspective view of a food steaming assembly according to an embodiment of the disclosure.

FIG. 2 is an exploded view of an embodiment of the disclosure.

FIG. 3 is a bottom view of an embodiment of the disclosure.

FIG. 4 is a side view of an embodiment of the disclosure.

FIG. 5 is an in-use view of an embodiment of the disclosure.

FIG. 6 is a cross-sectional view of an embodiment of the disclosure.

### DETAILED DESCRIPTION OF THE INVENTION

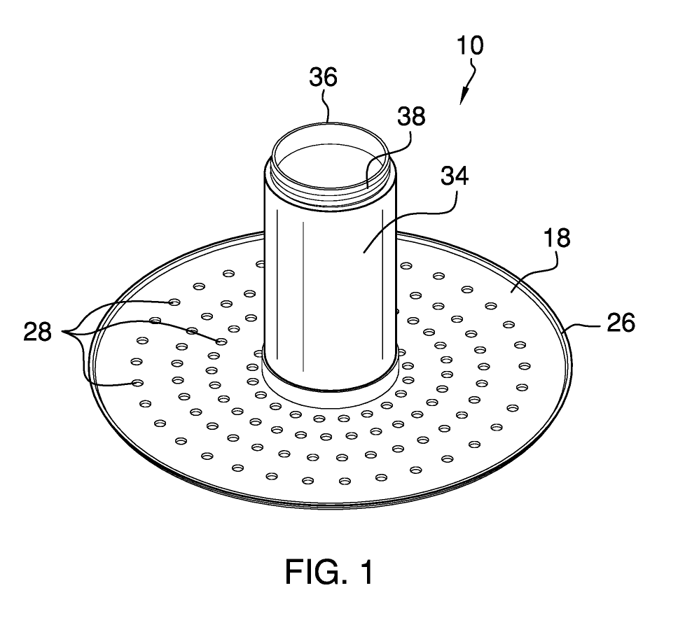

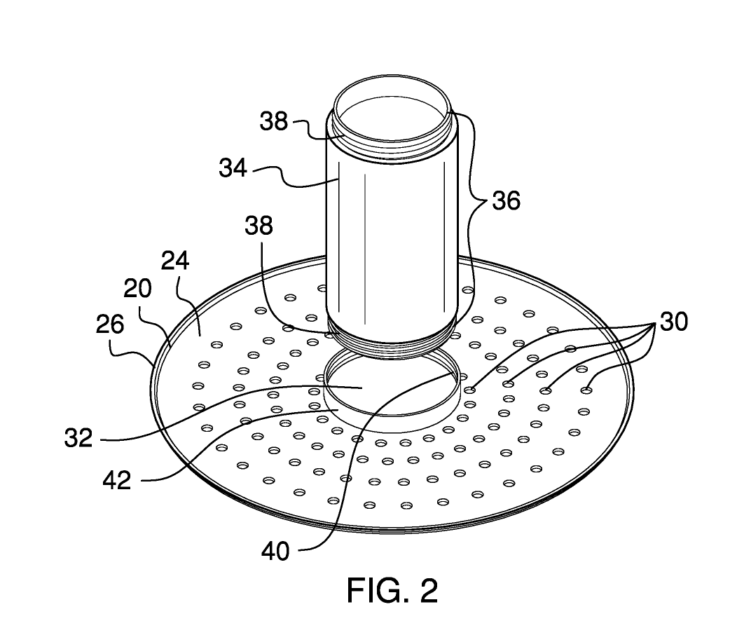

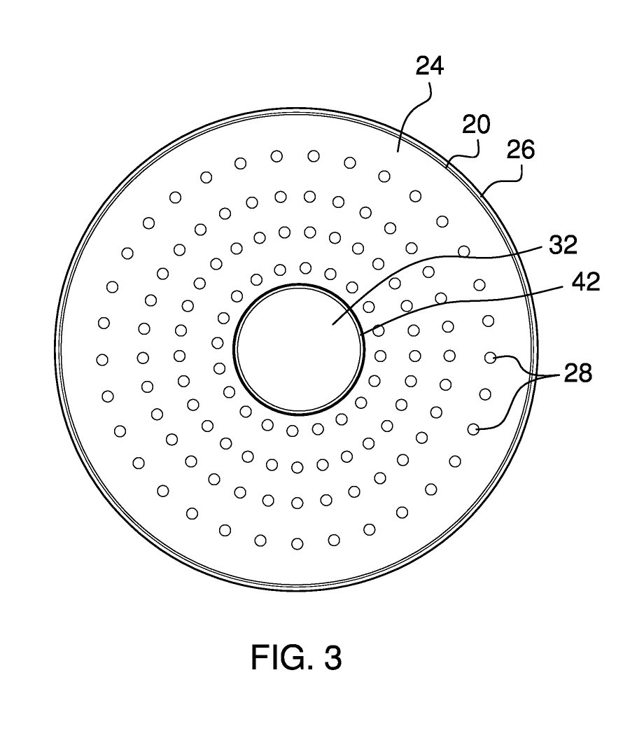

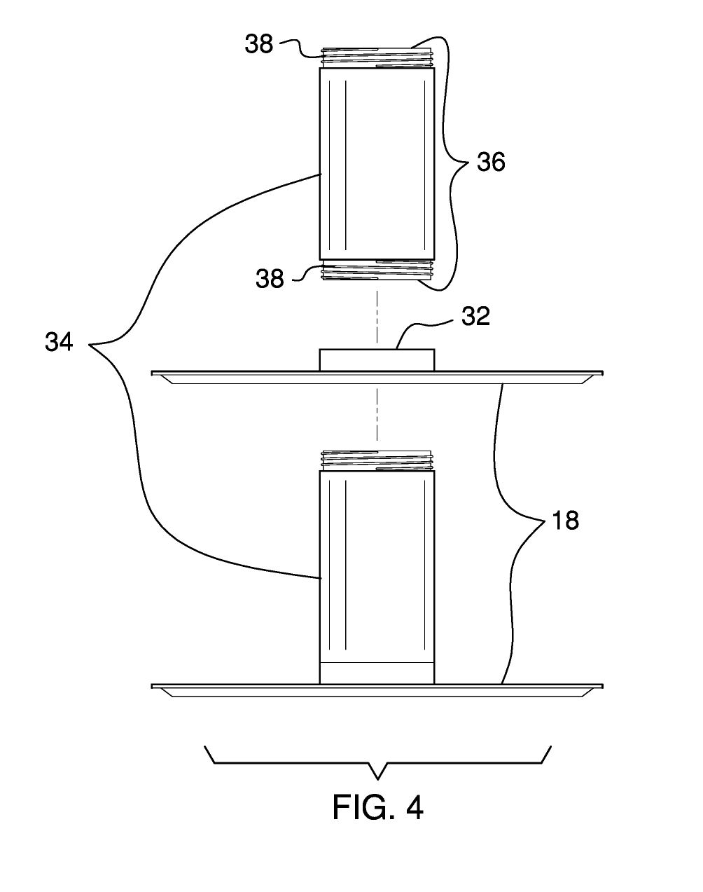

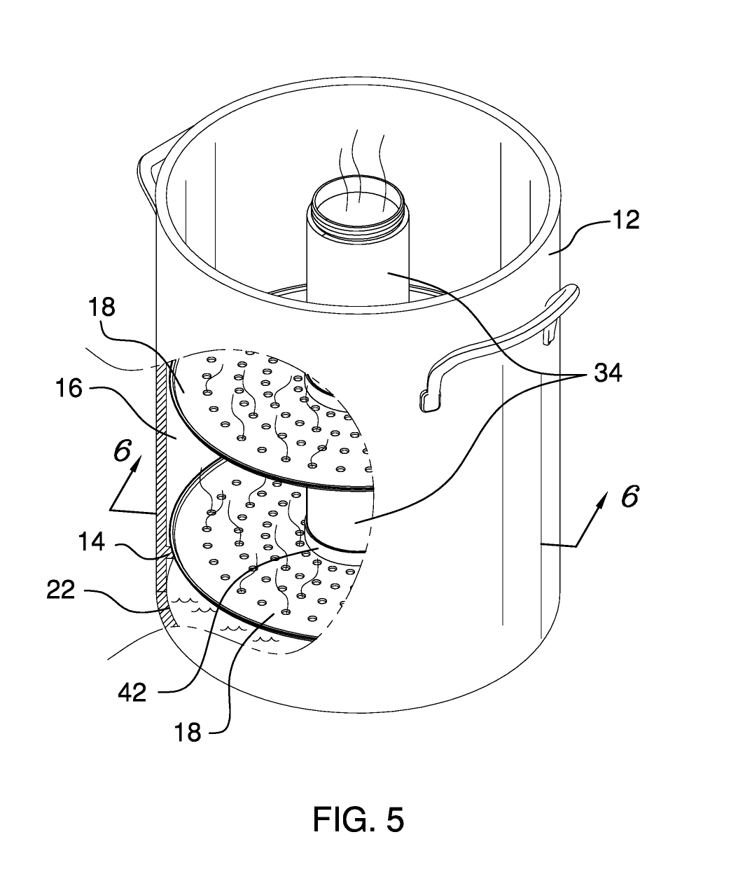

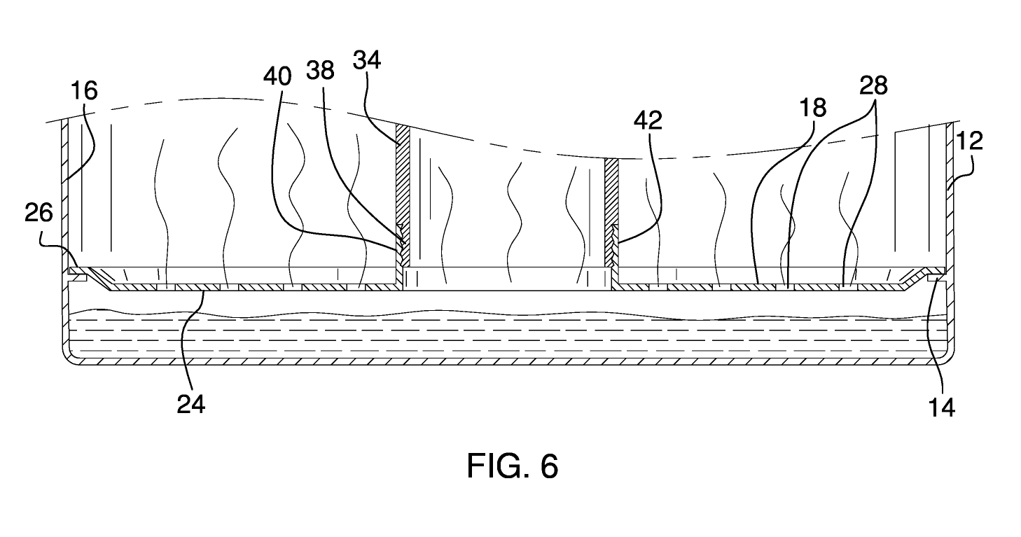

With reference now to the drawings, and in particular to FIGS. 1 through 6 thereof, a new steaming assembly embodying the principles and concepts of an embodiment of the disclosure and generally designated by the reference numeral 10 will be described.

As best illustrated in FIGS. 1 through 6, the food steaming assembly 10 generally comprises a pot 12 that is configured to position water. An extrusion 14 is coupled to and extends from an inner surface 16 of the pot 12.

The assembly 10 comprises a tray 18. The tray 18 has a circumference 20 that is substantially complementary to a perimeter 22 of the pot 12. The tray 18 is positionable within the pot 12 on the extrusion 14 and above the water. In one embodiment, the tray 18 comprises a plate 24. A rim 26 is coupled to and extends from the plate 24 to define the circumference 20 of the tray 18. A plurality of holes 28 is positioned through the plate 24. The holes 28 are configured to allow steam to pass through the holes 28 to heat food items that are positioned on the plate 24. In another embodiment, the holes 28 are positioned in a plurality of concentric circles 30. In yet another embodiment, the plurality of concentric circles 30 comprises four concentric circles 30.

An aperture 32 is centrally positioned through the tray 18. In one embodiment, the aperture 32 is circularly shaped.

The assembly 10 comprises a tube 34 that has opposing ends 36. Each opposing end 36 is complementary to the aperture 32. The opposing end 36 of the tube 34 is reversibly couplable to the tray 18 such that the tube 34 is alignably positioned with the aperture 32. The tube 34 is configured to allow a user to observe a level of the water that is positioned in the pot 12. The tube 34 also is configured to allow the user to add water, as required, through the tube 34 into the pot 12.

Each of a pair of first fasteners 38 is coupled to a respective opposing end 36 of the tube 34. A second fastener 40 couple to the tray 18. The second fastener 40 is complementary to the first fasteners 38. The second fastener 40 is positioned to couple to a respective first fastener 38 to couple the tube 34 to the tray 18.

In one embodiment, the second fastener 40 comprises a ring 42 that is coupled to and extends from the tray 18. The ring 42 is internally threaded. In this embodiment, the tube 34 is externally threaded proximate to each opposing end. The ring 42 is positioned to couple to two tubes 34. The opposing ends 36 of the tube 34 are positioned to couple to two trays 18. The trays 18 and the tubes 34 are stackable within the pot 12.

In use, the pot 12 is positioned to insert the tray 18. The tray 18 is positionable within the pot 12 on the extrusion 14 and above the water that is positioned in the pot 12. The ring 42 is positioned to couple to two tubes 34. The opposing ends 36 of the tube 34 are positioned to couple to two trays 18. The trays 18 and the tubes 34 are stackable within the pot 12. The tube 34 is positioned on the tray 18 such that the tube 34 is configured for the user to observe the level of the water in the pot 12. The tube 34 also is configured for the user to add water, as required, through the tube 34 into the pot 12. The holes 28 through the plate 24 are configured to allow the steam to pass through the holes 28 to heat the food items that are positioned on the plate 24.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A food steaming assembly comprising:
a pot configured for positioning water;
an extrusion coupled to and extending from an inner surface of said pot;
a tray having a circumference substantially complementary to a perimeter of said pot such that said tray is positionable within said pot on said extrusion and above the water;
an aperture centrally positioned through said tray;
a tube having opposing ends, each said opposing end being complementary to said aperture, said opposing end of said tube being reversibly couplable to said tray such that said tube is alignably positioned with said aperture; and
wherein said tube is positioned on said tray such that said tube is configured for a user to observe a level of the water positioned in said pot, and wherein said tube is configured for adding water, as required, through said tube into said pot.

2. The assembly of claim 1, further including said tray comprising:
a plate;
a rim coupled to and extending from said plate defining said circumference of said tray;
a plurality of holes positioned through said plate; and
wherein said holes are positioned through said plate such that said holes are configured for steam to pass through said holes to heat food items positioned on said plate.

3. The assembly of claim 2, further including said holes being positioned in a plurality of concentric circles.

4. The assembly of claim 3, further including said plurality of concentric circles comprising four said concentric circles.

5. The assembly of claim 1, further including said aperture being circularly shape.

6. The assembly of claim 5, further comprising:
a pair of first fasteners, each said first fastener being coupled to a respective said opposing end of said tube;
a second fastener couple to said tray, said second fastener being complementary to said first fasteners; and
wherein said second fastener is positioned on said tray such that said second fastener is positioned for coupling to a respective said first fastener to couple said tube to said tray.

7. The assembly of claim 6, further comprising:
said second fastener comprising a ring coupled to and extending from said tray, said ring being internally threaded;
said tube being externally threaded proximate to each said opposing end, wherein said ring is positioned on said tray such that said ring is positioned for coupling to two said tubes; and
wherein said opposing ends are positioned on said tube such that each said tube is positioned for coupling to two said trays, such that said trays and said tubes are positioned for stackable positioning within said pot.

9. A food steaming assembly comprising:
a pot configured for positioning water;
an extrusion coupled to and extending from an inner surface of said pot;
a tray having a circumference substantially complementary to a perimeter of said pot such that said tray is positionable within said pot on said extrusion and above the water, said tray comprising:
a plate,
a rim coupled to and extending from said plate defining said circumference of said tray, and
a plurality of holes positioned through said plate, wherein said holes are positioned through said plate such that said holes are configured for steam to pass through said holes to heat food items positioned on said plate, said holes being positioned in a plurality of concentric circles, said plurality of concentric circles comprising four said concentric circles;
an aperture centrally positioned through said tray, said aperture being circularly shaped;
a tube having opposing ends, each said opposing end being complementary to said aperture, said opposing end of said tube being reversibly couplable to said tray such that said tube is alignably positioned with said aperture, wherein said tube is positioned on said tray such that said tube is configured for a user to observe a level of the water positioned in said pot, and wherein said tube is configured for adding water, as required, through said tube into said pot;
a pair of first fasteners, each said first fastener being coupled to a respective said opposing end of said tube;
a second fastener couple to said tray, said second fastener being complementary to said first fasteners, wherein said second fastener is positioned on said tray such that said second fastener is positioned for coupling to a respective said first fastener to couple said tube to said tray, said second fastener comprising a ring coupled to and extending from said tray, said ring being internally threaded, said tube being externally threaded proximate to each said opposing end, wherein said ring is positioned on said tray such that said ring is positioned for coupling to two said tubes, and wherein said opposing ends are positioned on said tube such that each said tube is positioned for coupling to two said trays, such that said trays and said tubes are positioned for stackable positioning within said pot; and
wherein said pot is positioned for inserting said tray such that said tray is positionable within said pot on said extrusion and above the water positioned in said pot, wherein said ring is positioned on said tray such that said ring is positioned for coupling to two said tubes, and wherein said opposing ends are positioned on said tube such that each said tube is positioned for coupling to two said trays, such that said trays and said tubes are positioned for stackable positioning within said pot, wherein said tube is positioned on said tray such that said tube is configured for the user to observe a level of the water positioned in said pot, wherein said tube is configured for adding water, as required, through said tube into said pot, wherein said holes are positioned through said plate such that said holes are configured for the steam to pass through said holes to heat the food items positioned on said plate.
